(19) United States
(12) Patent Application Publication
(10) Pub. No.: US 2014/0043582 A1
(43) Pub. Date: Feb. 13, 2014

(54) EYEGLASSES HANGER

(71) Applicant: Mike Paydar, San Jose, CA (US)

(72) Inventor: Mike Paydar, San Jose, CA (US)

(21) Appl. No.: 13/568,696

(22) Filed: Aug. 7, 2012

(51) Int. Cl. G02C 3/00

(52) U.S. Cl. CPC G02C 3/00
USPC 351/155

(57) ABSTRACT

An eyeglasses hanger includes a ring sized to receive a temple of eyeglasses so that the eyeglasses can hang from the ring. The ring is mounted on a structure that is configured to attach to various articles such as clothing, a metal surface or the rear view mirror of a car.

### BACKGROUND

Eyeglasses, also known as glasses, spectacles or specs, are lenses held by frames worn in front of an individual's eyes. Eyeglasses are typically worn to enhance vision or to protect eyes from, for example, flying debris or from eye-damaging radiation. Eyeglasses can also be worn by the fashion conscious or for other aesthetic reasons.

Eyeglasses are usually not worn continuously. For example, eyeglasses are typically not worn while sleeping. Some eyeglasses are only use for reading or other close-up work. Other eyeglasses, such as sunglasses, may only be worn when one is outside or while driving. Other eyeglasses may be used only when performing certain tasks that threaten eye safety. And so on.

When eyeglasses are not being used, they are stored, perhaps in a case or a holder. It is easy for the absent minded, the busy, or the distracted to misplace their glasses. This can result in time spent searching for misplaced eyeglasses.

### BRIEF DESCRIPTION OF DRAWINGS

FIG. 1 and FIG. 2 show an eyeglasses hanger for attachment to a car rear view mirror in accordance with an implementation.

FIG. 3 and FIG. 4 and FIG. 5 show a pen with an eyeglasses hanger in accordance with an implementation.

FIG. 6 and FIG. 7 show an eyeglasses hanger that holds multiple eyeglasses in accordance with an implementation.

FIG. 8 and FIG. 9 show an eyeglasses hanger with a clip in accordance with an implementation

### DETAILED DESCRIPTION

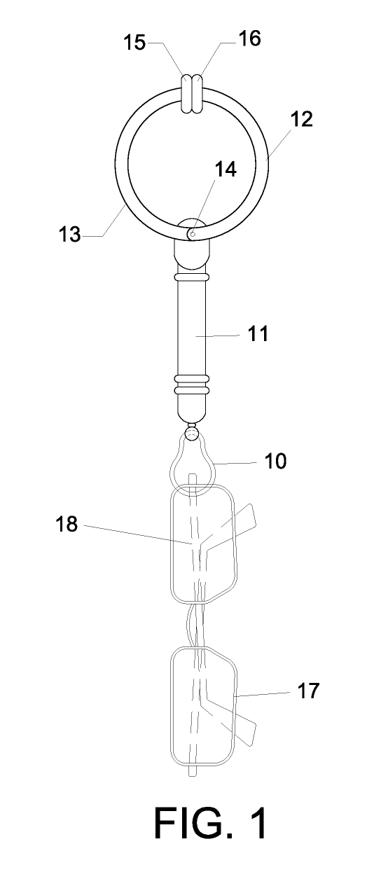

FIG. 1 show an eyeglasses hanger for attachment to a car rear view mirror. The eyeglasses hanger includes a base 11 and a ring 10. A temple 18 of eyeglasses 17 fits through ring 10 allowing eyeglasses 17 to be held in a hanging position by the eyeglasses hanger. For example, ring 10 is composed of metal, nylon, rubber or some other suitable material.

The eyeglasses hanger attach to a car rear view mirror by a support 13 and a support 12 attached to base 11 at a hinge 14. For example base 11, support 12 and support 13 are composed of wood, plastic, metal or some other suitable material. A fastener such as magnet 15 and magnet 16 hold support 12 and support 13 together, keeping the eyeglasses hanger from falling away from the car rear view mirror. Alternatively, another type of fastener, such as a clasp, could be used in place of magnet 15 and magnet 16.

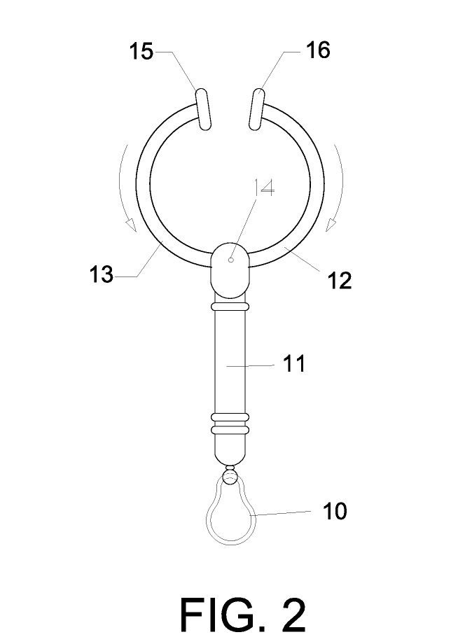

FIG. 2 shows the eyeglasses hanger of FIG. 1 in an unfastened position, ready to be attached to a rear view mirror mount or removed from the rear view mirror mount. For example, once support 12 and support 13 are placed around a rear view mirror mount, magnet 15 is placed in contact with magnet 16 thus holding the eyeglasses hanger in place on the rear view mirror mount.

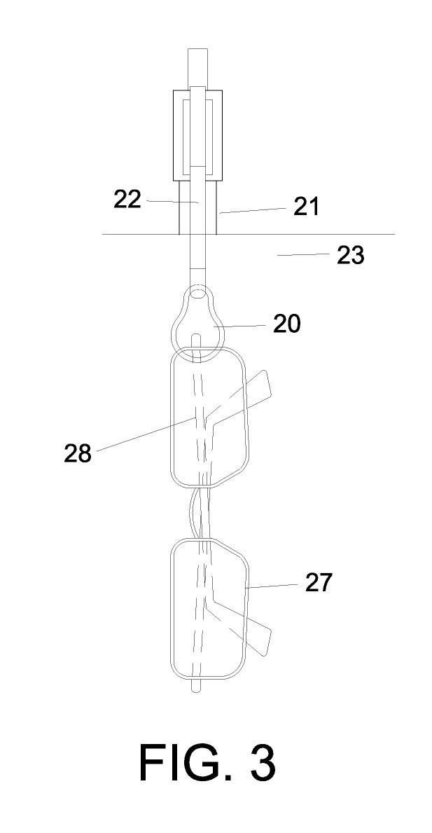

FIG. 3 shows a pen with an integrated eyeglasses hanger composed of a ring 20 attached to a pen clip 22 of a pen body 21. When pen body 21 is clipped to a pocket 23, as illustrated by FIG. 3, temple 28 of eyeglasses 27 fits through ring 20 allowing eyeglasses 27 to be held in a hanging position by the eyeglasses hanger.

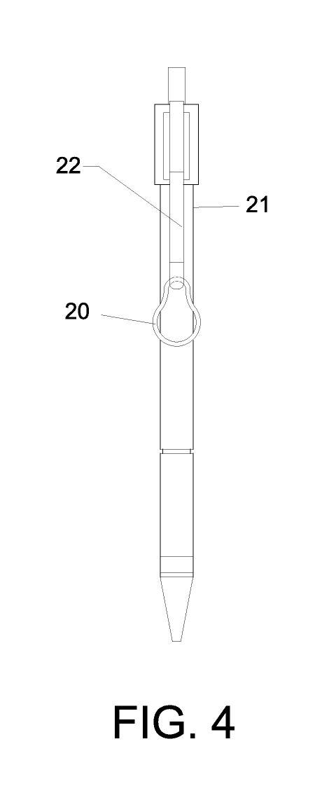

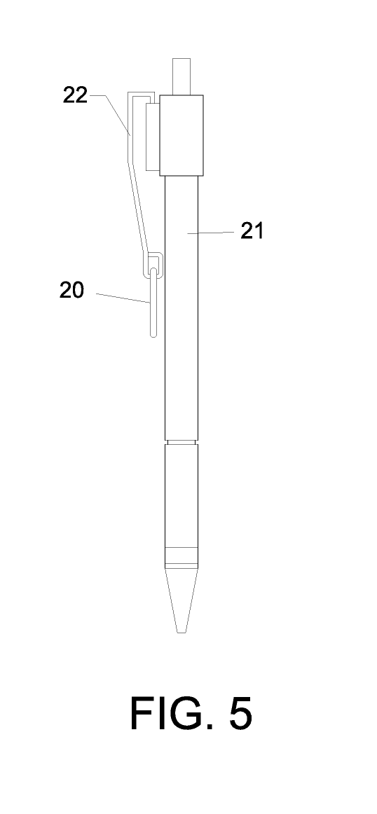

FIG. 4 shows a front view of pen body 21, pen clip 22 and ring 20. FIG. 5 shows a side view of pen body 21, pen clip 22 and ring 20.

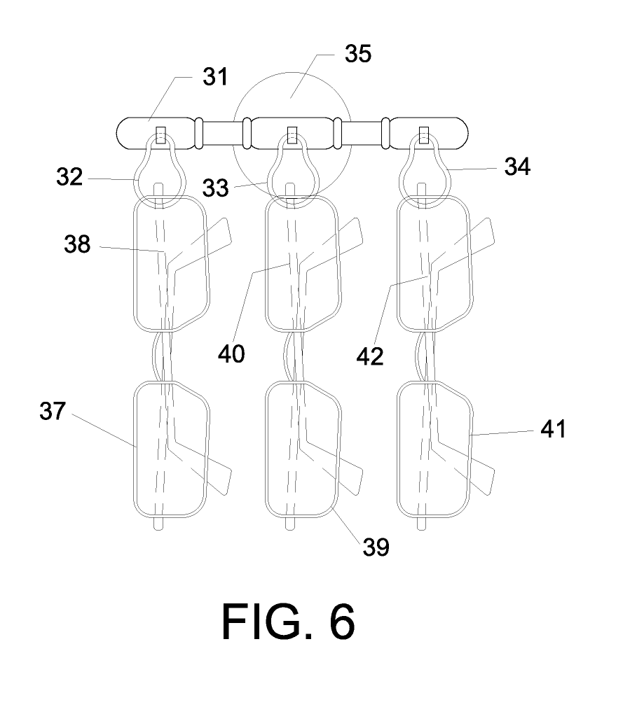

FIG. 6 shows an eyeglasses hanger that holds multiple eyeglasses. The eyeglasses hanger includes a support 31, a base 35, a ring 32, a ring 33 and a ring 34. A temple 38 of eyeglasses 37 fits through ring 32 allowing eyeglasses 37 to be held in a hanging position. A temple 40 of eyeglasses 39 fits through ring 33 allowing eyeglasses 37 to be held in a hanging position. A temple 42 of eyeglasses 41 fits through ring 34 allowing eyeglasses 37 to be held in a hanging position.

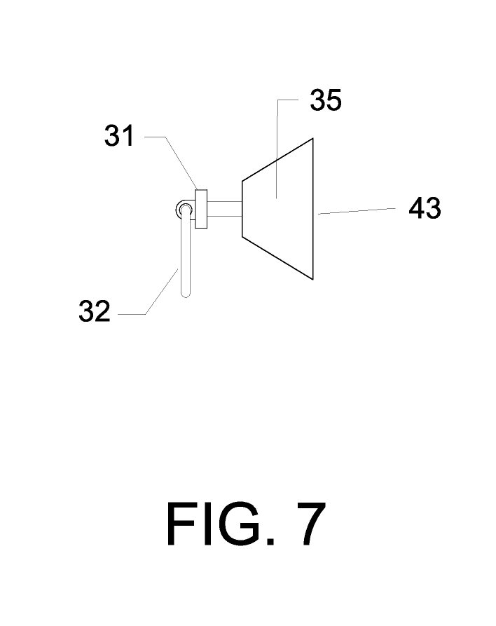

FIG. 7 shows a side view of support 31, base 35 and ring 32. An adhesive or a magnet placed on a back 43 of base 35 allows base 35 to attach to a surface such as a refrigerator door, wall, cabinet side, desk hutch, book case, door window or so on.

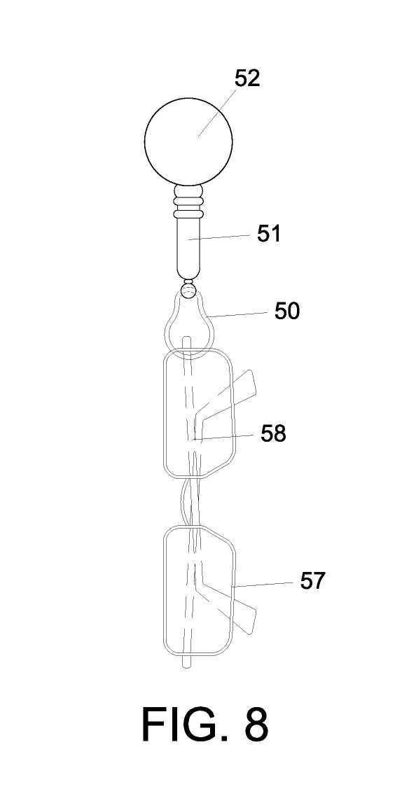

FIG. 8 shows an eyeglasses hanger having a support 51, a base 52 and a ring 50. A temple 58 of eyeglasses 57 fits through ring 50 allowing eyeglasses 57 to be held in a hanging position.

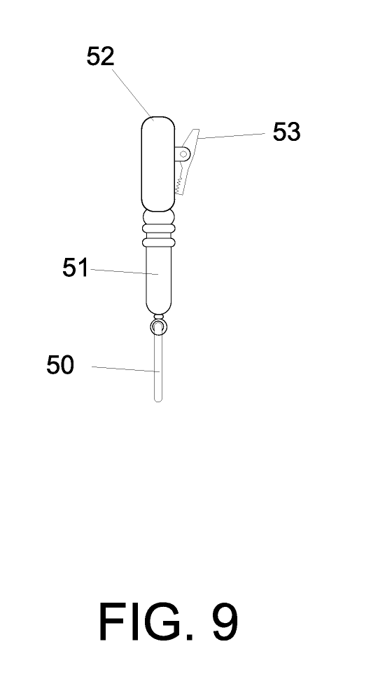

FIG. 9 shows a side view of support 51, base 52 and ring 50. A clip 53 attached to base 52 allows the eyeglasses hanger to be attached, for example, to clothing such as at a pocket or at a seam. Clip 53 can also be used to attach the eyeglass hanger to a book, a piece of furniture or any other object that has a suitable place where clip 53 can be attached.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. An eyeglasses hanger for hanging eyeglasses from a rear view mirror comprising:
a base;
a first support;
a second support;
a hinge that connects the first support and the second support to the base;
a fastener that holds the first support to the second support when the first support and the second support are placed around a rear view mirror mount;
a ring, attached to the base, the ring being sized to receive a temple of the eyeglasses so that the eyeglasses can hang from the ring.

2. An eyeglasses hanger as in claim 1 wherein the fastener includes a first magnet on a first end of the first support and a second magnet on a first end of the second support.

3. A pen with an integrated eyeglasses hanger comprising:
a pen body;
a pen clip; and,
a ring, attached to the pen clip, the ring being sized to receive a temple of the eyeglasses so that the eyeglasses can hang from the ring.

4. An eyeglasses hanger for hanging a plurality of eyeglasses, the eyeglasses hanger comprising:
a base;
support connected to the base;
a plurality of rings, each ring in the plurality of rings being attached to the support, each ring in the plurality of rings being sized to receive a temple of one of the plurality of the eyeglasses.

5. An eyeglasses hanger as in claim 4 additional comprising:
an adhesive located on a back of the base used to attach the base to a surface.

6. An eyeglasses hanger as in claim 4 wherein the base includes a magnetized surface allowing the base to be magnetically attached to a metal surface.

7. An eyeglasses hanger comprising:
a base have a clip suitable for clipping the base to a pocket;
a support connected to the base; and,
a ring, attached to the support, the ring being sized to receive a temple of eyeglasses so that the eyeglasses can hang from the ring.
